(19) United States
(12) Patent Application Publication
(10) Pub. No.: US 2005/0198674 A1
(43) Pub. Date: Sep. 8, 2005

(54) Cinema fiber optic platform

(76) Inventors: Freddie Lin, Redondo Beach, CA (US); Gary Fong, San Gabriel, CA (US); Duke Tran, Huntington Beach, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 11/055,449

(22) Filed: Feb. 10, 2005

Related U.S. Application Data
(60) Provisional application No. 60/546,784, filed on Feb. 20, 2004.

(51) Int. Cl. H04N 7/18

(52) U.S. Cl. 725/78

(57) ABSTRACT

An optical fiber-based distribution system for converting color video and stereo audio electrical signals for transmission over the fewest possible number of optical fiber cables and for then re-converting such signals back to electrical format for use at each projection room in a multi-theater complex. The color video signals include the red R, green G and blue B color video signals and attendant synchronization signals, horizontal synch H and vertical synch V. The audio signals include left L and right R channel stereo signals. The five electrical video signals R, G, B, V, H are converted in an RGB transmitter to three distinct optical signals for transmission over three fiber optic cables and the two electrical audio stereo signals L, R are converted in a stereo audio transmitter for transmission over one fiber optic cable. The three optical signals from the RGB transmitter are then re-converted in a remote receiver back into the R, G, B, V, H electrical signals while the one optical signal from the stereo audio transmitter is re-converted in a remote receiver back into the L, R electrical signals. Wavelength division multiplexing may be employed to transmit all of the optical signals of video modulation on just one fiber optic cable. Audio modulation optical signals may also be transmitted over the same fiber optic cable using wavelength division modulation.

### CROSS-RELATED APPLICATIONS

This application takes priority from Provisional Patent Application Ser. No. 60/546,784 filed Feb. 20, 2004.

### BACKGROUND OF THE INVENTION

1. Field of the Invention

The present invention relates generally to the field of data transmission over fiber optic cables and more specifically to a system for transmitting video and audio signals over fiber optic cables such as in a cinema complex for presenting satellite-relayed advertising material in respective theater auditoriums.

2. Background Art

Modern movie theater complexes typically comprise a plurality of individual auditoriums each showing a different motion picture. Also typical is the presentation of various forms of advertising such as those offering goods and services of local businesses. Such advertising is often time sensitive in response to frequent changes and additions including changes in content and the addition of new business subscribers who wish to exploit this rapidly expanding advertising medium. In order to accommodate such frequent changes and additions, the advertising portion of the typical cinema's program is relayed from a central location via satellite to numerous theater complexes where that portion is received in each complex's hub location. The data, in the form of color video and stereo audio, is then distributed within the theater complex to the projection room of each individual theater auditorium to be shown to each theater's audience.

Such distribution should be accomplished in a manner which is reliable, which retains the quality of the video and audio signals without significant degradation and which does not require an overwhelming number of cumbersome cables to be routed throughout the theater complex. Yet this has to be accomplished between the complex's hub location and sometimes as many as several dozen projection rooms, some of which may be thousands of feet away.

The most advantageous distribution system therefore, is one which would provide broadband and low attenuation signal transfer in the fewest possible number of cables over relatively long distances with the least transmission equipment cost.

### SUMMARY OF THE INVENTION

The present invention comprises an optical fiber-based distribution system for converting color video and stereo audio electrical signals for transmission over the fewest possible number of optical fiber cables and for then re-converting such signals back to electrical format for use at each projection room in a multi-theater complex. The color video signals include the red R, green G and blue B color video signals and attendant synchronization signals, horizontal synch H and vertical synch V. The audio signals include left L and right R channel stereo signals.

In one embodiment of the invention, the five electrical video signals R, G, B, V, H are converted in an RGB transmitter to three distinct optical signals for transmission over three fiber optic cables and the two electrical audio stereo signals L, R are converted in a stereo audio transmitter for transmission over one fiber optic cable. The three optical signals from the RGB transmitter are then re-converted in a remote receiver back into the R, G, B, V, H electrical signals while the one optical signal from the stereo audio transmitter is re-converted in a remote receiver back into the L, R electrical signals. Thus, in one preferred embodiment, the present invention provides a system for converting five color video signals and two stereo signals in electrical form into four separate optical fiber light modulated signals for transmission to a remote location where the optical signals are re-converted back into electrical signals.

The described embodiment of the present invention provides a number of significant and advantageous features including:
1) video synch mode selection;
2) automatic video polarity detection;
3) video synch tip clamping;
4) video amplitude/threshold compare;
5) blanking signal extraction;
6) clamping the blanking signal to ground;
7) encoding five independent analog video signals into three optical signals;
8) laser power feedback control;
9) video receiver wideband DC-coupled closed loop;
10) video receiver peak to peak synch extraction;
11) wideband analog linear optical video receiver;
12) maximum receiver optical power adjustment;
13) video receiver differential output noise compensation;
14) wide dynamic range video;
15) differential analog audio architecture to achieve 95 db THD+N, 100 db dynamic range and 20 Hz to 20 kHz frequency range; and
16) use of 96 kHz sampling rate and 24-bit digital conversion for audio.

The most advantageous embodiment of the invention employs wavelength division multiplexing to combine at least all of the video modulated optical signals into just one fiber optical cable. Audio modulated optical signals may also be transmitted over the same fiber optic cable so that each auditorium in a theater complex receives five channels of video and two channels of audio over one fiber optic cable.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a simplified block diagram of a satellite-based cinema advertising data link with which the present invention is designed to operate;

FIG. 2 is a simplified block diagram of a video and audio interface converting electrical to optical to electrical provided by each hub to projection room link;

FIG. 3 is a block diagram of an RGB transmitter of a preferred embodiment of the invention;

FIG. 3a is a waveform diagram of typical RGB and HV input signals;

FIG. 3b is a waveform diagram of the optical output of the RGB transmitter;

FIG. 4 is a block diagram of an RGB receiver of a preferred embodiment;

FIG. 4a is a waveform diagram of a received optical input after AGC;

FIG. 4b is a waveform diagram of a typical RGB and HV output of the RGB receiver;

FIG. 4c is a simplified block diagram showing the use of coarse wavelength division multiplexing and demultiplexing to further reduce the number of fiber optic cables;

FIG. 5, comprising FIGS. 5a and 5b, shows by respective block diagram the stereo audio transmitter and receiver of a preferred embodiment;

FIG. 6 is a simplified schematic diagram of an analog input filter used in the preferred embodiment of the stereo audio transmitter;

FIG. 7 is a simplified schematic diagram of an analog output filter used in the preferred embodiment of the stereo audio receiver; and

FIG. 8 is a simplified schematic diagram showing a conversion of format used in the stereo audio transmitter of FIG. 6.

### DETAILED DESCRIPTION OF A PREFERRED EMBODIMENT

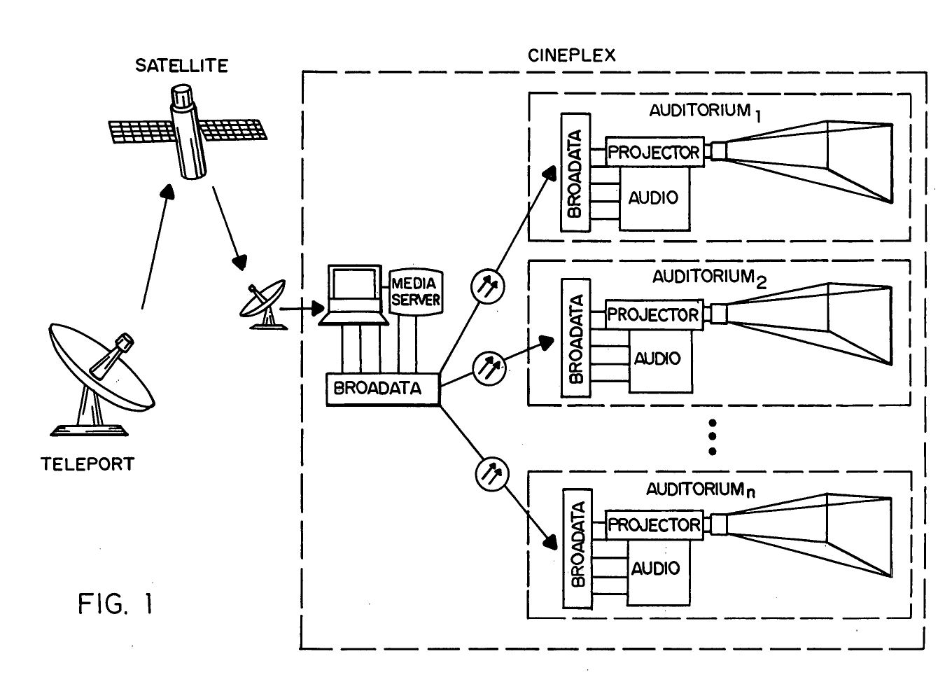

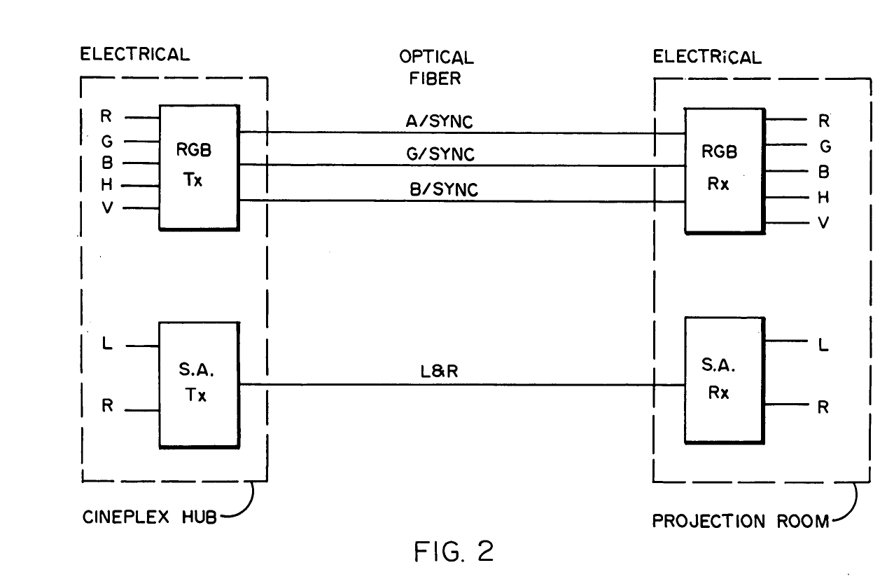

Referring to FIG. 1, it will be seen that in a typical cinema advertising system, the content material is relayed by satellite to a movie theater complex or “cineplex” where it is received at a hub media server. At this location, the content may be modified to add theater credit and the like before it is distributed to the individual projection rooms of the respective theaters or auditoriums of the complex where it can be shown on respective auditorium screens and heard through respective auditorium speakers at the appropriate time in the program. Depending upon the number of auditoriums in the theater complex, the hub media server feeds the various electrical signals of the color video and stereo audio to a plurality of RGB and stereo audio transmitters for conversion into optical signals for transmission over fiber optic cables to the respective individual auditoriums. As shown in FIG. 2, seven electrical signals (five video—R, G, B, H, V and two audio—L, R) are input to two transmitters, namely, an RGB transmitter (R.G.B. Tx) and a stereo audio transmitter (S.A. Tx). The five video signals are converted in the RGB Tx to be applied as three optical signals R/Syn, G/Syn and B/Syn onto three fiber optic cables. The two audio signals are converted in the S.A. Tx to be applied as one optical signal L+R onto one fiber optic cable. These four optical fibers are routed to the projection room of a remotely located theater auditorium. Clearly, there is an additional set of transmitters RGB Tx and S.A. Tx for each additional remotely located theater auditorium. The four optical fibers are connected in the projection room to receivers RGB Rx and S.A. Rx. The RGB Rx receiver receives the three optical fibers carrying the optical signals R/Syn, G/Syn and B/Syn. The S.A. Rx receiver receives the one optical fiber carrying the optical signal L+R. The receivers re-convert the optical signals back into electrical signals. Thus, RGB Rx produces the signals R, G. B, H, V and S.A. Rx produces L, R.

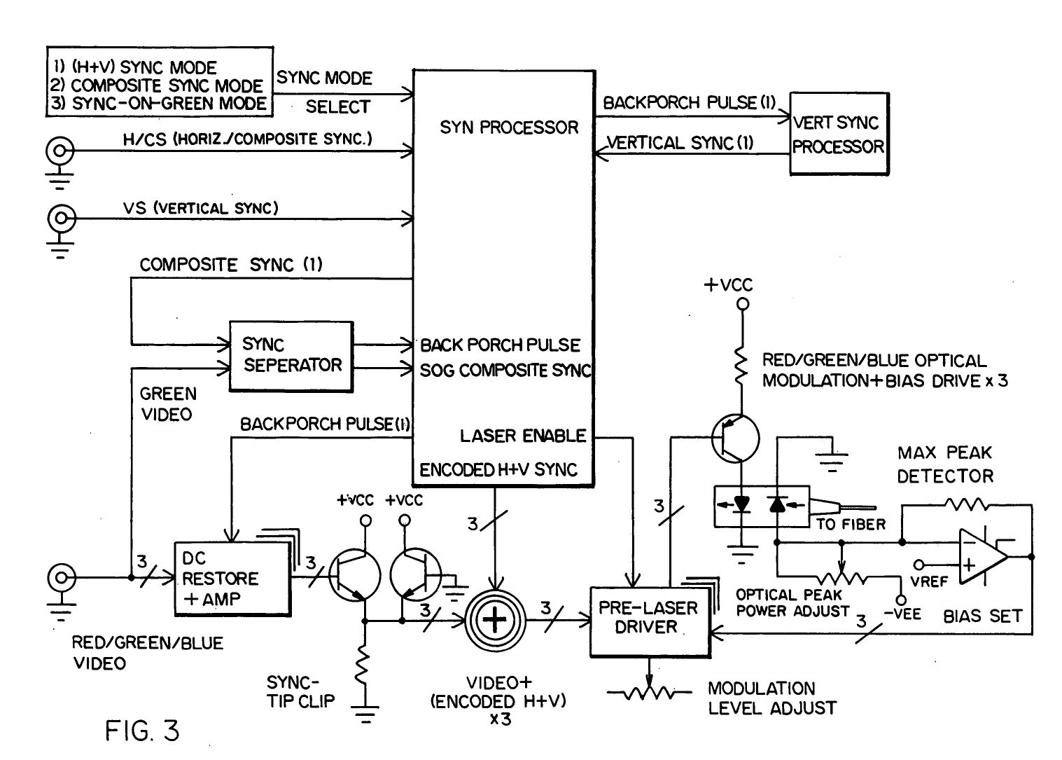

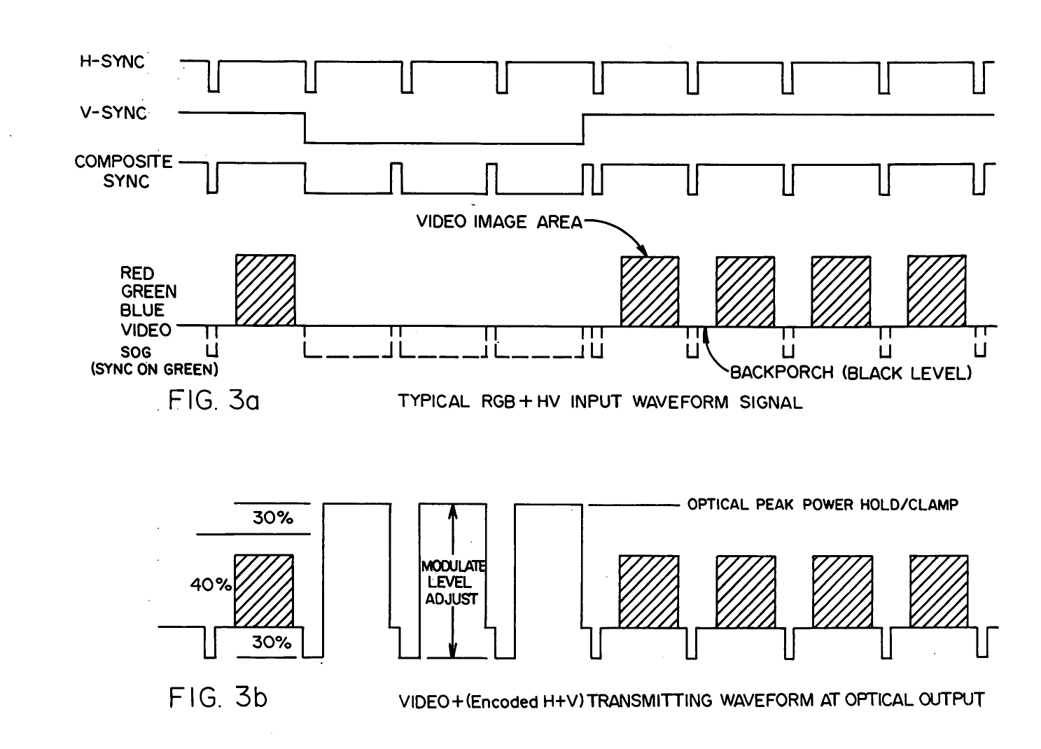

The implementation of the transmitters and receivers is explained in detail in conjunction with FIGS. 3 to 8.

RGB TX and RX

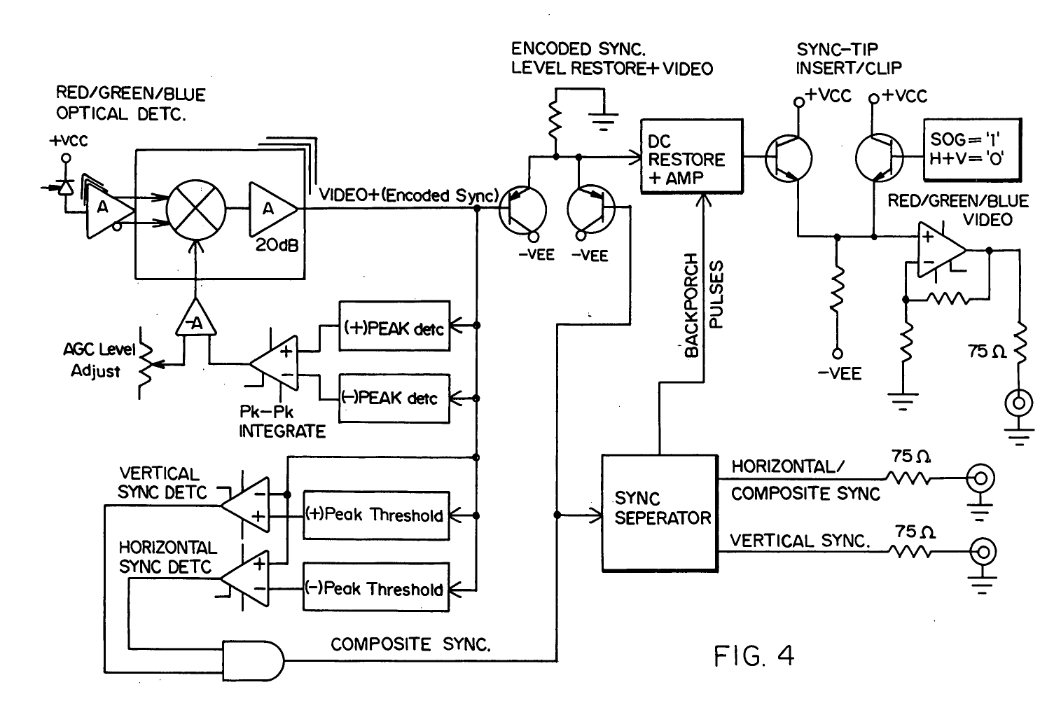

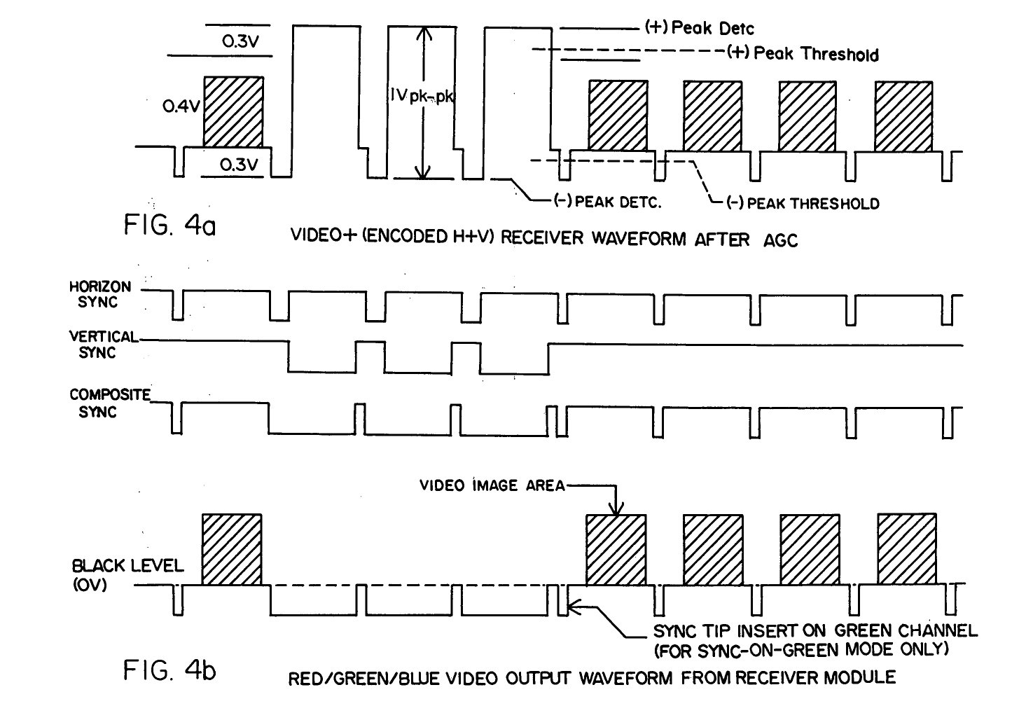

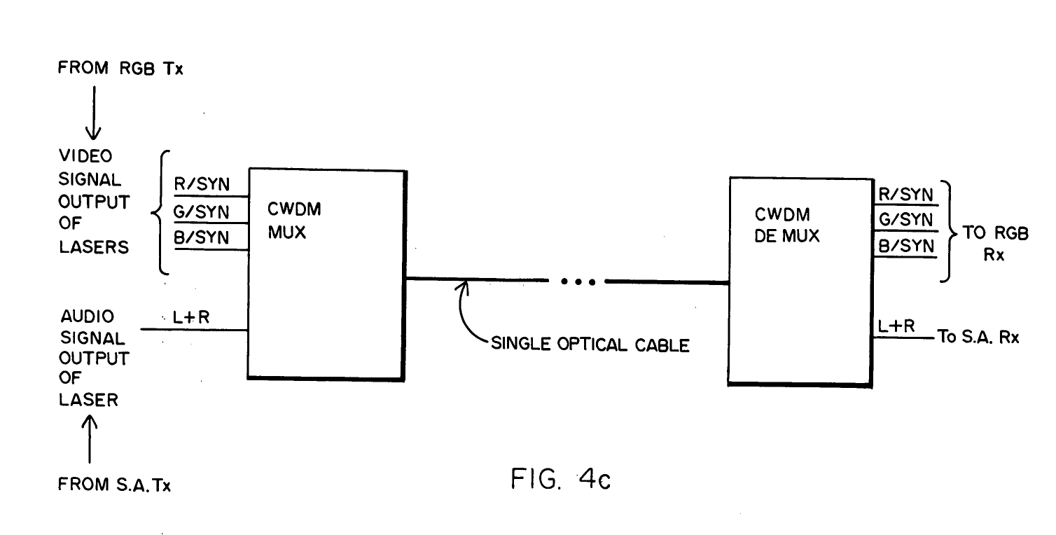

The video RGB transmitter is shown in block diagram form in FIG. 3 while the video RGB receiver is shown in block diagram form in FIG. 4. Various waveforms related to the RGB TX are shown in FIGS. 3a and 3b and various waveforms related to the RGB RX are shown in FIGS. 4a and 4b. RGB TX functions to combine each video color signal R, G or B with an encoded synchronization signal for modulating a laser light output for application to an optical fiber. Because it is designed to operate with all types of multi-rate, multi-format color video synch schemes, each transmitter is capable of selecting any one of three synch modes of operation, namely, H+V synch; composite synch (“CS”); and synch-on-green (“SOG”). Irrespective of which synch mode is used, the synch pulses are applied to the SYN PROCESSOR for encoding H+V. However, because different synch schemes have to be accommodated, the RGB TX provides a “synch separator” which detects “synch-on-green (SOG) video” and separates out the SOG signal as an input to the SYN PROCESSOR. The “synch separator” also separates out the back porch pulse from composite synch “cs” which provides a reference for DC restoration (for SOG schemes) and vertical synch separation (for CS schemes). Each of the video signals V_{Red}, V_{Green}, V_{Blue} is applied to a corresponding DC Restore and Amplifier which provides a standardized black level and peak-to-peak voltage variation despite AC-coupled signal “wander” in the input video signals. The SOG synch tip is then clipped to avoid interference with the remaining modulation process. The processed video is then summed with the encoded H+V synch signal and applied as the modulating signal to an appropriate wavelength laser. The laser output is controlled by a power feedback loop through the positive peak of the encoded H+V synch signal to provide maximum available dynamic range without losing any video modulation from optical clipping. Typical RGB Tx input video signals are shown in FIG. 3a and a corresponding transmitting waveform of video+encoded H+V is shown in FIG. 3b. It will be understood that the RGB Tx is configured uniquely to process color video with any synchronization scheme, to separate out H and V synch signals, to provide a stable video signal of pre-determined peak-to-peak signal range regardless of input variations due to AC coupled sources, and to encode synch signals H+V and add them to each separate video color signal R, G, B to modulate an optical output, thereby providing three optical signals that contain the information corresponding to five input electrical signals.

RGB Rx is configured to demodulate each of the three color video+encoded H+V optical inputs while automatically controlling the input gain in a synch pk-pk controlled AGC for maximum peak-to-peak video, and restoring video and synch signal structures to their original format regardless of synchronization scheme. These functions are accomplished in the receiver illustrated in block diagram form in FIG. 4. FIG. 4a shows a waveform of the received video signal (one of three) after AGC. FIG. 4b shows the reconverted color video signal (one of three).

Because of the innovative design and encoding scheme of RGB Tx and RGB Rx, the preferred embodiment of the present invention provides the following unique features:
1) Capable of interfacing from high-end to low-end RGB+H/V equipment;
2) System provides video DC restoration in case of AC coupling type input signal
   a) Video signal wander
   b) Uni-polar output video signal (Black level/Sync-tip) above ground
3) Combines 5 inputs signal into 3 optical outputs
   a) Include automatic detect/process non-standard synch edge polarity of H & V
4) Utilize Horz and Vert sync encoding scheme to combine with video channel for optical transport process
   a) Optical Peak power feedback loop tracking
   b) Video peak-to-peak gage for Automatic Gain Control (AGC) feedback loop
   c) Template for ease of decoding and processing of Horz and Vert synch in the receiver module
5) Single system capable of operating 3 different RGB interface modes
   a) External Sync mode (H+V)
   b) Composite Sync mode (H/V combine)
   c) Sync-On-Green mode (Composite Sync on Green Video Channel)
      S.A. Tx and Rx

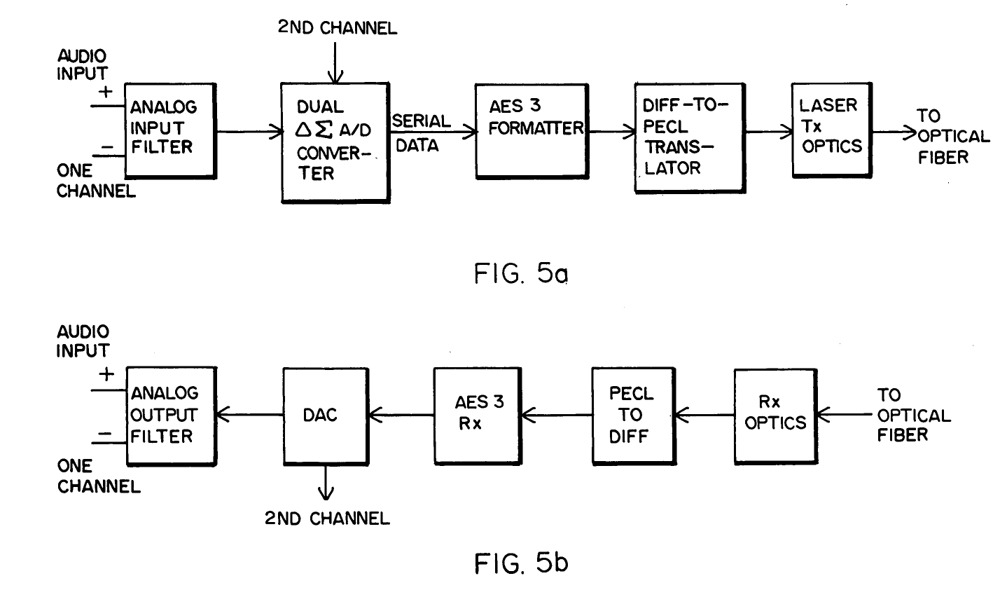

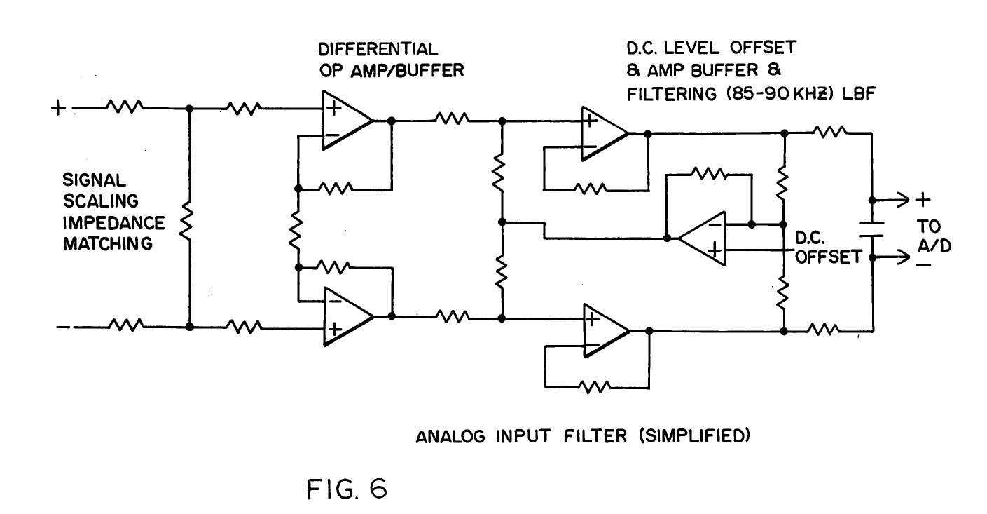

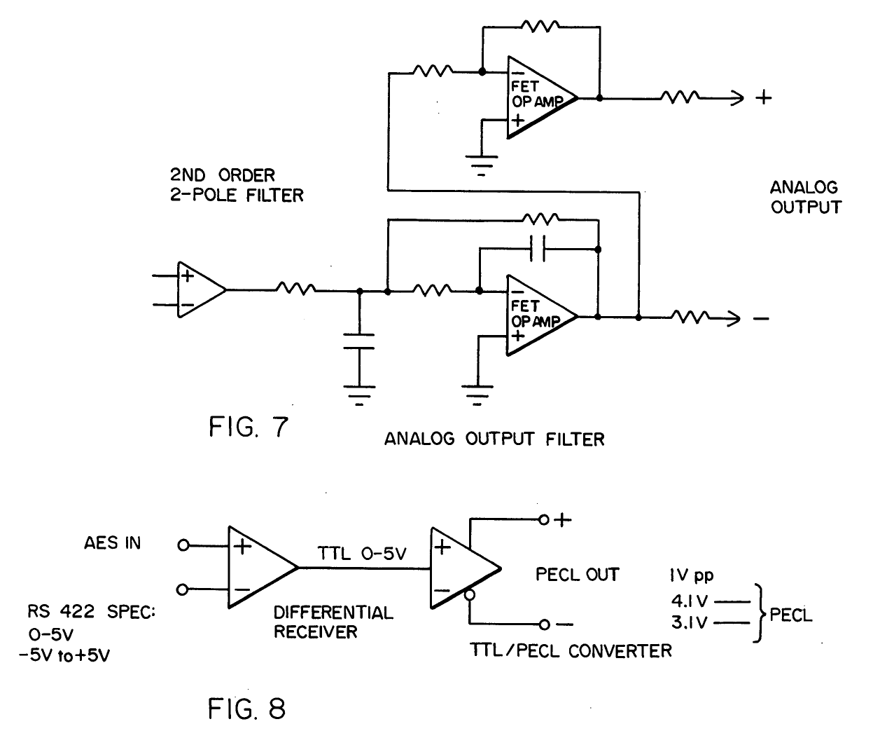

As seen in FIG. 5a, in the S.A. transmitter one channel of stereo audio (either L or R) is input as a differential signal to an analog input filter for filtering and scaling. FIG. 6 shows the analog input filter in a preferred embodiment as comprising a voltage divider first stage (for scaling and impedance matching). The input analog filter also comprises a second stage differential operational amplifier and buffer and a third stage DC level offset and low pass filter. The output of the analog input filter is then fed to a dual Δε (delta sigma) analog-to-digital converter which also receives the output of a second input analog filter for the second audio channel R or L (not shown in FIG. 5a). The A/D converter of the preferred embodiment employs a 96 kHz sampling rate and 24-bit digital format to provide extremely accurate audio signal conversion. The output of the A/D converter is a serial bit stream which is applied to an AES3 formatter and a differential to PECL translator (PECL=positive emitter coupled logic) which generates a balanced signal level for laser light modulation in a laser transmitter for application to a glass optical fiber. The differential-to-PECL translator is shown in block diagram form in FIG. 8. As seen therein, the translator comprises a differential receiver which converts the AES3 input to TTL logic levels in the 0 to 5V range and a TTL to PECL converter which converts the TTL 0 to 5V levels to PECL range of 3.1 V to 4.1 V with a 1V p-p output in that range.

The S.A. receiver shown in FIG. 5b is essentially the reverse of the transmitter of FIG. 5a. The optical fiber carrying L+R is input to an optical detector-based receiver which generates a serial data PECL output stream. This data stream is translated to a differential format input to an AES3 receiver and then input to a dual digital-to-analog converter which produces two separate channels of audio L, R. Each such channel has an analog output filter, shown in FIG. 7, to attenuate the harmonics due to digitization effect.

As shown in FIG. 7, each analog output filter comprises a second order 2-pole filter using a pair of FET operational amplifiers to produce a filtered differential output at a selected maximum peak-to-peak voltage level providing excellent linearity, dynamic range and audio frequency response.

As shown in FIG. 4c, by using wavelength division multiplexing (WDM), all of the modulated laser outputs may be fed into just one fiber optic cable. As seen in FIG. 4c, the three video signal modulated laser outputs and the audio signal modulated laser output are all input to a coarse wavelength division multiplexer (CWDM MVX) at the transmitter of a single fiber optic cable and all are recovered at a CWDM demux at the receiver end of the cable.

Having thus disclosed a preferred embodiment of the present invention, it will now be apparent that numerous additions and modifications may be made to the invention while still achieving the principal unique features thereof. Accordingly, it will now be understood that the scope of hereof is not limited to the specific examples described herein, but only by the appended claims and their equivalents.

1. A system for transmitting color video signals over a long distance; the system comprising:
a transmitter for converting red, green and blue video signals and vertical and horizontal synch signals into three modulated optical signals for transfer over at least one optical fiber; and
a receiver for re-converting said three optical signals received over said at least one optical fiber back into said video and synchronization signals.

2. The system recited in claim 1 wherein said transmitter and said receiver are each configured for operation with each of three video synchronization modes comprising: H+V synch; composite synch; and synch-on-green.

3. The system recited in claim 1 wherein said optical signals comprise R/Syn, G/Syn and B/Syn signals, each said optical signal being a color video signal summed with an encoded synchronization signal and modulating an optical laser output.

4. The system recited in claim 1 wherein said transmitter comprises three lasers each controlled by a power feedback loop.

5. The system recited in claim 1 further comprising a wavelength division multiplexer at said transmitter for transmitting said modulated optical signals over a single optical fiber and a wavelength division demultiplexer for separating said modulated optical signals at said receiver.

6. A system for distributing video and audio data from a first location in a theater complex to at least one distant second location in said complex; the system comprising:
a video signal;
a first transmitter for converting red, green and blue video signals and vertical and horizontal synch signals into three video signal modulated optical signals for transfer over at least one optical fiber interconnecting said first and second locations;
a first receiver for re-converting said three video signal modulated optical signals received over said at least one optical fiber back into said video and synchronization signals;
a second transmitter for converting left and right channel analog signals of stereo audio into one digitally modulated optical signal for transfer over an optical fiber; and
a second receiver for re-converting said digitally modulated optical signal received over said optical fiber back into said left and right channel analog signals of stereo audio.

7. The system recited in claim 6 wherein said first transmitter and said first receiver are each configured for operation with each of three video synchronization modes comprising: H+V synch; composite synch; and synch-on-green.

8. The system recited in claim 6 wherein said video signal modulated optical signals comprise R/Syn, G/Syn and B/Syn signals, each said video signal modulated optical signal being a color video signal summed with an encoded synchronization signal and modulating an optical laser output.

9. The system recited in claim 6 wherein said first transmitter comprises three lasers each controlled by a power feedback loop.

10. The system recited in claim 6 further comprising a wavelength division multiplexer at said first transmitter for transmitting said video signal modulated optical signals over a single optical fiber and a wavelength division demultiplexer for separating said video signal modulated optical signals at said first receiver.

11. A system for transmitting stereo audio signals over a long distance; the system comprising:
a transmitter for converting left and right channel analog signals of stereo audio into one digitally modulated optical signal for transfer over an optical fiber; and
a receiver for re-converting said optical signal received over said optical fiber back into said left and right channel analog signals of stereo audio.

12. The system recited in claim 11 wherein said transmitter comprises an A/D converter and said receiver comprises a D/A converter.

13. The system recited in claim 11 wherein said A/D converter has a sampling rate of at least 96 kHz and a digital output format of at least 24 bits.

14. The system recited in claim 11 wherein said transmitter and said receiver each employ a differential analog audio architecture.
